(19) United States
(12) Patent Application Publication
(10) Pub. No.: US 2006/0193548 A1
(43) Pub. Date: Aug. 31, 2006

(54) Sprocket support structure of travel drive for construction machine

(76) Inventors: Michio Hori, Kuwana-shi (JP); Hideshi Nishiwaki, Yokkaichi-shi (JP)

Correspondence Address: CLARK & BRODY, 1090 VERMONT AVENUE, NW, SUITE 250, WASHINGTON, DC, 20005, US

(21) Appl. No.: 11/353,047

(22) Filed: Feb. 14, 2006

(30) Foreign Application Priority Data
Feb. 16, 2005 (JP) JP2005-039375

(51) Int. Cl. F16C 33/58

(52) U.S. Cl. 384/571

(57) ABSTRACT

A travel drive comprises a driving shaft connected to a hydraulic motor (not shown), planet gear mechanisms, which reduces a rotational speed out of the driving shaft 2, a rotation drum rotatably supported by a housing by means of tapered roller bearings, and a sprocket fixed to the rotation drum. The tapered roller bearing comprises an inner ring, an outer ring, a tapered rollers disposed between the inner ring and the outer ring, and a retainer which retains a distance between the tapered rollers and is made of a resin.

### BACKGROUND OF THE INVENTION

1. Field of the Invention

The present invention relates to a sprocket support structure of a travel drive used for a construction machine and the like.

2. Description of the Background Art

A travel drive used for a construction machine is described in Japanese Unexamined Patent Publication No. 10-176718.

As shown in FIG. 1, the above document describes a travel drive 1 comprising a driving shaft 2 connected to a hydraulic motor (not shown), planet gear mechanisms 3, 4 and 5 which reduce a rotation speed of the driving shaft 2, a rotation drum 8 rotatably supported by a housing 7 by means of a bearing 6, and a sprocket 9 fixed to the rotation drum 8.

In many cases, an angular ball bearing or a back-to-back arrangement tapered roller bearing is used as the bearing 6 which supports travel drive 1 described in the above document, depending on its machine weight. The above bearing comprises a retainer made of metal in general.

Since the construction machine comprising the travel drive 1 travels around a place which is not in good condition in many cases, the bearing 6 supporting the rotation drum 8 receives large impact load intermittently. Thus, durability of the bearing could be lowered due to damage of the retainer.

In addition, since the metal retainer generates abrasion dust due to friction of the rotating bearing, the abrasion dust could be mixed in the lubrication oil to shorten a lubrication life or the abrasion dust could damage a rolling surface of the rolling element.

### SUMMARY OF THE INVENTION

It is an object of the present invention to provide a sprocket support structure of a travel drive for a construction machine having high durability and high efficiency.

According to the present invention, a sprocket support structure of a travel drive for a construction machine comprises a driving shaft, a sprocket, a speed reducing mechanism to reduce the rotation speed of the driving shaft and transfer it to the sprocket, and a tapered roller bearing supporting the sprocket.

The tapered roller bearing is characterized by comprising an inner ring, an outer ring, tapered rollers disposed between the inner ring and the outer ring, and a retainer formed of a resin.

As described above, when the retainer or a guiding member corresponding to the retainer is made of a resin having excellent impact resistance, durability of the bearing is improved. In addition, since the bearing uses the resin retainer which is light in weight and low in friction, torque loss at the time of rotation can be reduced, so that the sprocket support structure of the travel drive for the construction machine has high efficiency.

It is preferable that the retainer is formed of a fiber reinforced resin containing polyamide 66 and glass fiber, or it is preferable that the retainer is formed of a fiber reinforced resin containing polyamide 46 and glass fiber. Since the above fiber reinforced resin is light in weight and very strong, it is suitable for a retainer material used in the bearing which supports a sprocket of the travel drive for the construction machine which receives the impact load.

Furthermore, it is preferable that a pocket surface of a pillar part of the retainer positioned between adjacent pockets in which the tapered roller is received has a curved configuration which is to come in contact with a rolling surface of the tapered roller. Thus, since the lubrication oil is not scratched away, lubricant performance of the bearing can be enhanced.

For example, the tapered roller bearing is a double row tapered roller bearing in which the tapered rollers are arranged between the inner ring and the outer ring in double rows.

In addition, the tapered roller bearing is a back-to-back arrangement bearing in which small-diameter side ends of the tapered rollers in right and left rows are opposed.

According to the present invention, since the bearing using the resin retainer which is light in weight and low in friction is provided, the sprocket support structure of the travel drive for the construction machine has high durability and high efficiency.

### BRIEF DESCRIPTION OF THE DRAWINGS

FIG. 1 is a schematic sectional view showing a travel drive for a construction machine;

FIG. 2 is a schematic sectional view showing a tapered roller bearing according to the present invention;

FIG. 3 is a sectional view showing a pocket of a retainer used in a double row tapered roller bearing according to the present invention;

FIG. 4 is a view showing a result of a drop impact test to confirm an effect of the present invention; and

FIG. 5 is a view showing a retainer abrasion amount to confirm an effect of the present invention.

### DESCRIPTION OF THE PREFERRED EMBODIMENTS

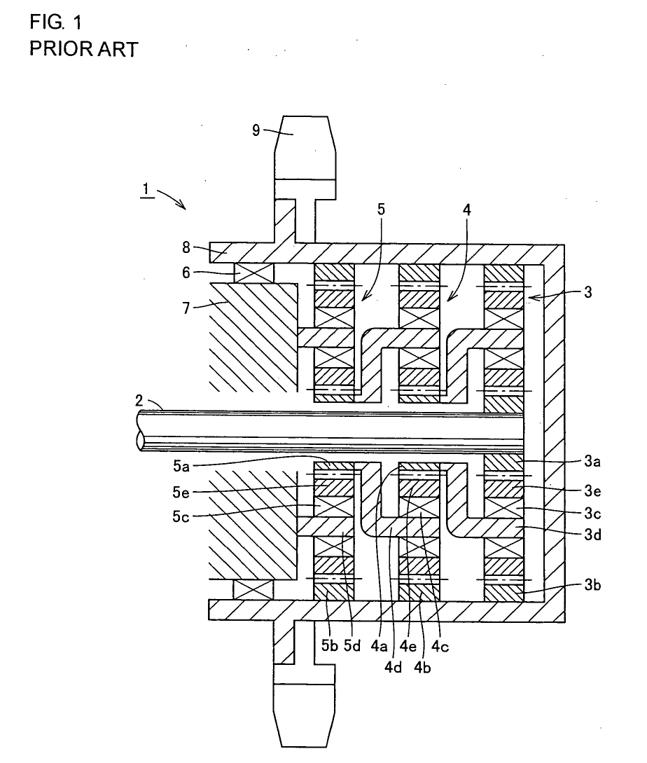

A sprocket support structure of a travel drive for a construction machine according to one embodiment of the present invention will be described with reference to FIG. 1.

A travel drive 1 for a construction machine shown in FIG. 1 comprises a driving shaft 2 connected to a hydraulic motor (not shown), planet gear mechanisms 3, 4 and 5 as speed reducing mechanisms which reduce a rotational speed out of the driving shaft 2, a rotation drum 8 rotatably supported by a housing 7 by means of a bearing 6 and a sprocket 9 fixed to the rotation drum 8.

The planet gear mechanisms 3, 4 and 5 comprise sun gears 3a, 4a and 5a, internal gears 3b, 4b and 5b connected to the rotation drum 8, and planet gears 3e, 4e and 5e rotatably supported by the planet carriers 3d, 4d and 5d by means of tapered roller bearings 3c, 4c and 5c between the sun gears 3a, 4a and 5a and the internal gears 3b, 4b and 5b, respectively.

In addition, the planet carrier 3d and the sun gear 4a, and the planet carrier 4d and the sun gear 5a are connected to each other and rotated in synchronization with each other. The planet carrier 5d is fixed to the housing 7 to control a revolution of the planet gear 5e.

According to the travel drive 1, the rotational speed out of the driving shaft 2 is reduced by the planet gear mechanisms 3, 4 and 5 in stages and the planet gear 5e of the planet gear mechanism 5 is controlled, so that the sun gear 5a rotates the internal gear 5b through the planet gear 5e. As a result, the rotation drum 8 and sprocket 9 can be integrally rotated.

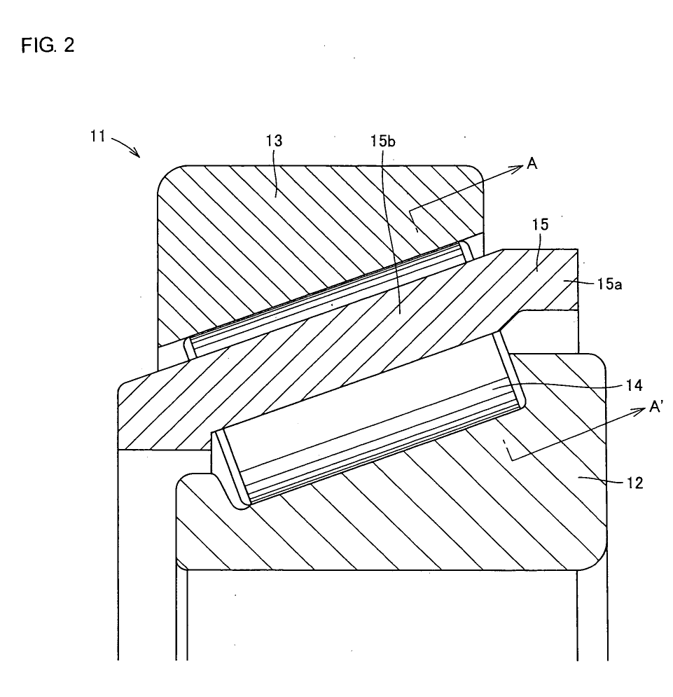

As shown in FIG. 2, as the bearing 6 supporting the travel drive 1 having the above constitution, a tapered roller bearing 11 is used, which comprises an inner ring 12, an outer ring 13, and a tapered roller 14 disposed between the inner ring 12 and the outer ring 13, and a retainer 15 which retains a distance between the tapered rollers 14. The retainer 15 or a guide member corresponding to it is made of a resin which is superior in shock resistance, light in weight and low in friction.

In this constitution, since impact resistance of the retainer is considerably improved, the tapered roller bearing 11 has high durability.

In addition, the tapered roller bearing 11 having the above constitution is lubricated with oil. In this case also, since friction between the roller and the retainer can be reduced by self-lubricating property of the resin, deterioration of the lubrication oil due to abrasion dust is prevented.

Furthermore, when a resin which is low in hardness is used, even if the abrasion dust is generated, a rolling surface of the tapered roller is not damaged. As a result, the tapered roller bearing can provide high durability and high lubricant property.

The resin retainer 15 can provide the same strength as that of the metal retainer when its thickness is increased within a range in which it is not in contact with orbital planes of the inner ring 12 and the outer ring 13.

In addition, the retainer 15 may be made of a fiber reinforced resin containing polyamide 66 and glass fiber or a fiber reinforced resin containing polyamide 46 and glass fiber. Since the fiber reinforce resin is light in weight and strong, it is appropriately used for the retainer material which is used in the bearing to support the sprocket of the travel drive for the construction machine which receives impact loading.

In addition, a fiber reinforced resin containing carbon fiber or boron fiber instead of the glass fiber may be used.

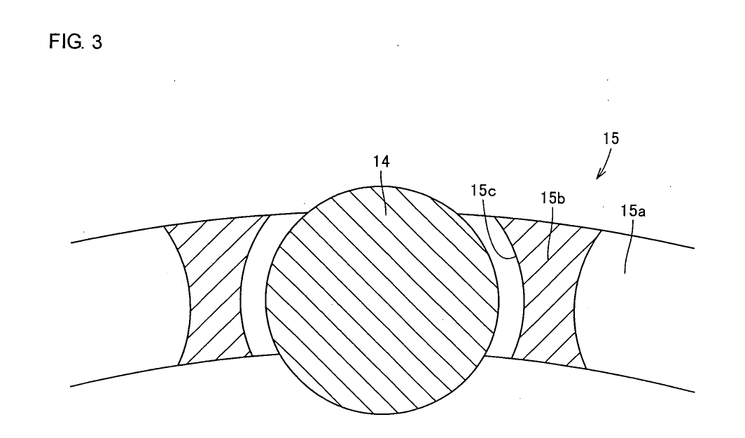

FIG. 3 is a sectional view showing the retainer 15 taken along line A-A′ in FIG. 2. According to FIG. 3, the retainer 15 comprises a ring part 15a and a pillar part 15b positioned between adjacent pockets in which the tapered roller 14 is received. A pocket surface 15c of the pillar part 15b has a curved configuration which is to come in contact with the rolling surface of the tapered roller 14.

Thus, since the lubrication oil on the rolling surface of the tapered roller is not scratched away, lubricant performance of the bearing can be enhanced. In addition, since the pocket surface 15c has the curved configuration, a thickness of the pillar part 15b can be increased, so that strength of the retainer is improved. Furthermore, when a connection part between the ring part 15a and the pillar part 15b is round-chamfered, the lubricant performance of the tapered roller bearing 11 can be also improved.

Although the pocket surface 15c of the retainer 15 has the curved configuration along the rolling surface of the tapered roller 14 in FIG. 3, the present invention is not limited to this, and it may have a straight configuration like the conventional retainer.

In addition, although the single-row tapered roller bearing is shown in the above embodiment, the present invention is not limited to this, and a double row tapered roller bearing may be used. In this case, although it may be a face-to-face arrangement bearing in which large-diameter side ends of the tapered rollers are opposed, when it is a back-to-back arrangement bearing in which small-diameter side ends of the tapered rollers are opposed, a distance between a rotation center line of the bearing and an intersecting point of a contact line of the inner and outer rings with the tapered rollers of the right and left rows is increased (referred to as the distance between the working points hereinafter), so that radial rigidity can be improved.

In addition, the present invention can be applied to a deep-grooved ball bearing, a four-point contact ball bearing, an angular ball bearing, a cylinder roller bearing, a self-aligning roller bearing and the like instead of the tapered roller bearing.

When the tapered roller bearing 11 having the above constitution is used as the bearing 6 shown in FIG. 1, since torque loss at the time of rotation can be reduced, the sprocket support structure of the travel drive for the construction machine has high efficiency.

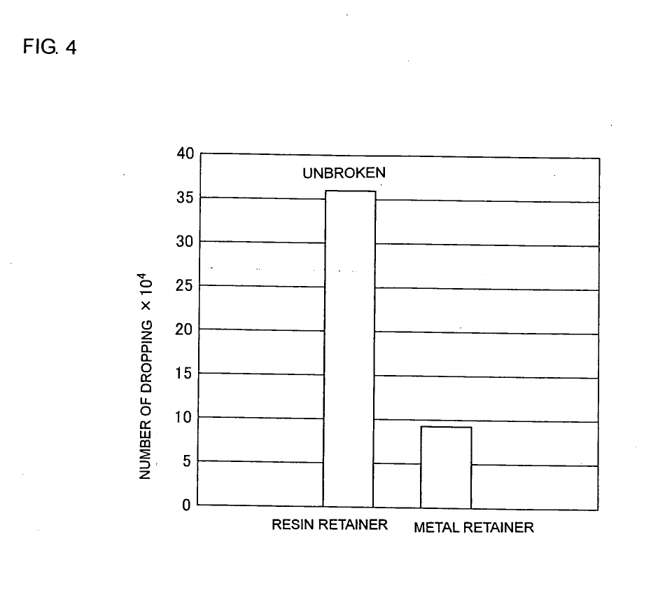

Next, a drop impact test was performed to the resin retainer according to the present invention and to the conventional metal retainer under the following conditions and impact resistance of each retainer was examined. Its result is shown in FIG. 4.

Dropped height: 80 mm

Vibration acceleration : 9800 m/s²

Drop cycle: 30 cpm

According to FIG. 4, while the conventional metal retainer was broken before 100,000 times, the resin retainer according to the present invention was not broken even after 360,000 times. Thus, it was confirmed that the impact resistance of the resin retainer according to the present invention is considerably improved as compared with the conventional metal retainer.

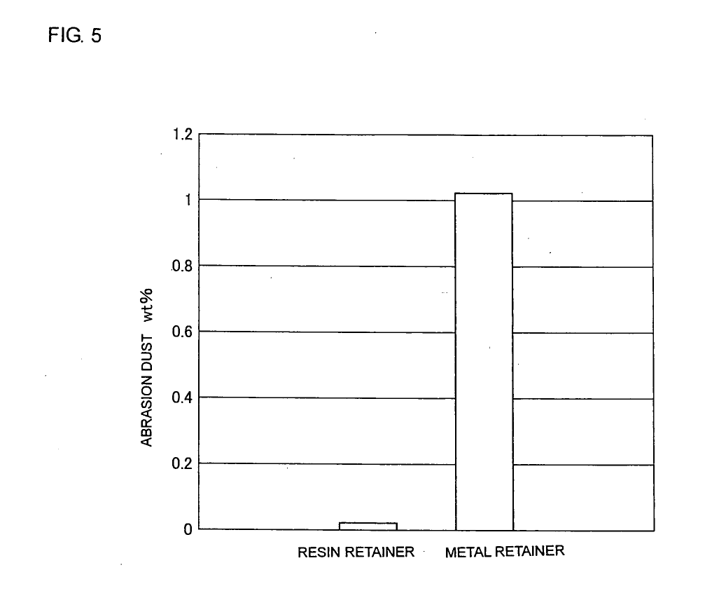

Furthermore, a test for confirming an amount of abrasion dust was performed after the resin retainer according to the present invention and the conventional metal retainer were rotated predetermined number of times. The test condition is as follows and its result is shown in FIG. 5.

Rotation speed: 2215 rpm (maximum rotation speed)

Radial load: 49±9.8 kN (10 Hz)

Axial load: 0±14.7 kN (1 Hz)

Operation time: 2120 hours

Wind speed: 10 m/s

After the above test, the amount of the abrasion dust of the resin retainer and the metal retainer were measured to find that while it was 1.03 wt % in the metal retainer, it was 0.02 wt % in the resin retainer.

Thus, it was confirmed that abrasion resistance of the resin retainer according to the present invention was considerably improved as compared with the conventional metal retainer.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

The present invention is advantageously applied to the tapered roller bearing having the retainer.

What is claimed is:

1. A sprocket support structure of a travel drive for a construction machine comprising:
a driving shaft;
a sprocket;
a speed reducing mechanism to reduce a rotational speed out of said driving shaft and transfer it to said sprocket; and
a tapered roller bearing supporting said sprocket, characterized in that
said tapered roller bearing comprises an inner ring, an outer ring, tapered rollers disposed between said inner ring and said outer ring, and a retainer made of a resin.

2. The sprocket support structure of the travel drive for the construction machine according to claim 1, wherein said retainer is made of a fiber reinforced resin containing polyamide 66 and glass fiber.

3. The sprocket support structure of the travel drive for the construction machine according to claim 1, wherein said retainer is made of a fiber reinforced resin containing polyamide 46 and glass fiber.

4. The sprocket support structure of the travel drive for the construction machine according to claim 1, wherein a pocket surface of a pillar part of said retainer positioned between adjacent pockets in which said tapered roller is received has a curved configuration which is to come in contact with a rolling surface of said tapered roller.

5. The sprocket support structure of the travel drive for the construction machine according to claim 1, wherein said tapered roller bearing is a double row tapered roller bearing in which said tapered rollers are arranged between said inner ring and said outer ring in double rows.

6. The sprocket support structure of the travel drive for the construction machine according to claim 5, wherein said tapered roller bearing is a back-to-back arrangement bearing in which small-diameter side ends of said tapered rollers in right and left rows are opposed.
